(19) United States
(12) Patent Application Publication
(10) Pub. No.: US 2010/0063197 A1
(43) Pub. Date: Mar. 11, 2010

(54) COMPOSITIONS AND METHODS FOR IMPARTING WATER AND OIL REPELLENCY TO FIBERS AND ARTICLES THEREOF

(76) Inventors: Robert B. COLLIER, Cohutta, GA (US); Geary FORD, Calhoun, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/554,415

(22) Filed: Sep. 4, 2009

Related U.S. Application Data
(60) Provisional application No. 61/094,524, filed on Sep. 5, 2008.

(51) Int. Cl. C08L 75/04

(52) U.S. Cl. 524/507

(57) ABSTRACT

Described herein are compositions and methods for imparting water and oil repellency to fibers. The compositions are composed of (a) a fluorinated polyurethane having a plurality of ionizable groups and (b) an acrylic polymer. Also described herein are fibers and articles treated with the compositions and methods described herein.

CROSS REFERENCE TO RELATED APPLICATIONS

This application claims priority upon U.S. provisional application Ser. No. 61/094,524, filed Sep. 5, 2008. This application is hereby incorporated by reference in its entirety for all of its teachings.

### BACKGROUND

Carpet is generally exposed to a number of different substances that can stain and ultimately diminish the appearance of carpet. The substances can be hydrophilic and/or hydrophobic in nature. Although individual formulations exist for repelling water based materials and oil based materials, it would be desirable to have a formulation that repels both water and oil to prolong the appearance and durability of carpet and other related fibers. It would also be desirable to have a formulation that does not present environmental concerns when applied to fibers typically exposed to water and oil based contaminants. The compositions and methods described herein address these needs.

### SUMMARY

Described herein are compositions and methods for imparting water and oil repellency to fibers. The compositions are composed of (a) a fluorinated polyurethane having a plurality of ionizable groups and (b) an acrylic polymer. Also described herein are fibers and articles treated with the compositions and methods described herein. Additional advantages of the compositions, methods, and articles described herein will be set forth in part in the description that follows, and in part will be apparent from the description. The advantages of the compositions, methods, and articles described herein will be realized and attained by means of the elements and combination particularly pointed out in the appended claims. It is to be understood that both the foregoing general description and the following detailed description are exemplary and explanatory only and are not restrictive of the compositions, methods, and articles described herein, as claimed.

### DETAILED DESCRIPTION

The compositions, methods, and articles described herein can be understood more readily by reference to the following detailed description. It is also to be understood that the terminology used herein is for the purpose of describing particular aspects only and is not intended to be limiting.

It must be noted that, as used in the specification and the appended claims, the singular forms “a,” “an” and “the” include plural referents unless the context clearly dictates otherwise. Thus, for example, reference to “an acrylic polymer” includes mixtures of acrylic polymers.

Described herein are compositions form imparting water and oil repellency to fibers typically exposed to water and oil based substances. The compositions are composed of (a) a fluorinated polyurethane having a plurality of ionizable groups and (b) an acrylic polymer. As will be shown below, the combination of the fluorinated polyurethane and acrylic polymer impart enhanced water and oil repellency to fibers when compared to the repellent properties of the individual components. Each component is described in detail below.

The fluorinated polyurethane is generally the reaction product between a diisocyanate and a perfluoropolyether having at least two hydroxyl groups. The diisocyanate can be an aliphatic, cycloaliphatic, or aromatic, compound. Examples of diisocyanates include, but are not limited to, hexamethylendiisocyanate (HDI), trimethylhexamethylenediisocyanate, isophorone diisocyanate (IPDI), 4,4′-methylenebis(cyclohexylisocyanate) (H12-MDI), cyclohexyl-1,4-diisocyanate, 4,4′-methylenebis(phenylisocyanate) (MDI) or its isomers, toluene 2,4-diisocyanate (TDI) or its isomers, xylylene diisocyanate, naphthalene-1,5-diisocyanate, p-phenylendiisocyanate, and tetramethyl-xylylenediisocyanate (TMXDI).

With respect to the perfluoropolyether, in certain aspects it is end-capped with hydroxyl groups such that they can react with an isocyanate group to produce the corresponding urethane. The perfluoropolyether can be composed of a variety of different repeat units including, but not limited to (C₃F₆O), (CF₂CF₂O), (CF(CF₃)O), (CF₂O) (CF₂(CF²)ₓCF₂O) wherein x' is an integer equal to 1 or 2, or (CF₂CF₂CH₂O). The molecular weight of the perfluoropolyether can also vary. In one aspect, the molecular weight of the perfluoropolyether is less than 5,000. In other aspects, the molecular weight is from 500, to 4,000, from 1,000 to 3,000, from 1,000 to 2,000, or about 1,500. In one aspect, the perfluoropolyether is a fluorinated propyl ether, which is referred to in the art at times as “C3.” In certain aspects, it is desirable that the perfluoropolyether not contain higher molecule weight derivatives such as fluorinated octyl ethers (C8) and analogs thereof, as these compounds pose environmental and health risks.

The fluorinated polyurethane also has at least one ionizable group. Ionizable groups are classified as either cationic or anionic. Cationic ionizable groups are functional groups that when protonated form a positively charged group. Examples of such groups include amines, where protonation of the amine produces a positively charged quaternary ammonium group. Conversely, anionic ionizable groups are groups that possess one or more hydrogen atoms that can be deprotonated to produce negatively charged groups. Examples of such groups include carboxylic acids, where deprotonation of the acid produces a negatively charged carboxyl group. The ionizable groups can be incorporated into the fluorinated polyurethane using a variety of synthetic techniques. In one aspect, the ionizable group is present on the perfluoropolyether, which is then subsequently reacted with the diisocyanate. In other aspects, a diol having an ionizable group can be added to the reaction mixture of perfluoropolyether and diisocyanate. In this aspect, the diol is a monomer that is polymerized during the reaction. The cationic and anionic fluorinated polyurethanes and methods for making the same disclosed in U.S. Pat. No. 7,015,278 and U.S. Published Application No. 2005/0164010 can be used herein, the teachings of which are incorporated by reference in their entireties. In one aspect, the fluorinated polyurethane is Fluorolink® P56 manufactured by Solvay Solexis, which is a water dispersion of an anionic polyurethane with a perfluoropolyether backbone. In another aspect, the fluorinated polyurethane is Fluorolink® 5032 manufactured by Solvay Solexis, which is a water dispersion of a cationic polyurethane with a perfluoropolyether backbone.

In certain aspects, a single fluorinated polyurethane can have both cationic and anionic ionizable groups present on the polymer. In other aspects, the fluorinated polyurethane can be a mixture of polyurethanes, where the mixture is composed of a cationic fluorinated polyurethane (e.g., Fluorolink® 5032) and an anionic fluorinated polyurethane (e.g., Fluorolink® P56). As shown in the Examples, mixtures of cationic and anionic fluorinated polyurethanes can enhance oil and soil repellency without imparting any negative impact on water repellency. Additionally, the composition does not diminish the color of the fibers, which is another desirable feature. In the case of cationic fluorinated polyurethanes, these materials when used alone can adversely affect light fastness by removing dyes from the fiber. This is not the case with the compositions described herein.

The acrylic polymer can be a variety of different polymers known in the art. For example, the acrylic polymer can be a homopolymer or copolymer of acrylic acid, methacrylic acid, styrene, vinyl acrylic acid, or any combination thereof. In one aspect, the acrylic polymer has a T_{g} less than or equal to 30° C., less than or equal to 25° C., or less than or equal to 20° C. In other aspects, the acrylic polymer has a minimum film forming temperature (MFFT) of less than or equal to 30° C., less than or equal to 25° C., or less than or equal to 20° C. The molecular weight of the acrylic polymer can also vary. In one aspect, the acrylic polymer has a molecular weight from 10,000 to 2,000,000, 200,000 to 1,500,000, or 200,000 to 1,000,000.

In one aspect, the acrylic polymer is polyacrylic acid having a molecular weight from 200,000 to 1,000,000. Examples of polyacrylic acids useful herein include products manufactured by Specialty Polymers, Inc. under tradename RayCryl™ such as RayCry™ 708E (molecular weight of about 1,000,000, T_{g} of 21° C., and MFFT of 12° C.). Other examples of polyacrylic acids include products manufactured by Para Chem such as AC-763 (molecular weight greater than 200,000 and MFFT of 20° C.) and AC-767 (molecular weight greater than 200,000 and MFFT of 30° C.).

Depending upon the application of the composition, the composition can contain various other additives and components. In one aspect, the composition can optionally include a surfactant. Examples of surfactants include, but are not limited to, dispersants, emulsifiers, detergents, and wetting agents. Any of the surfactants disclosed in U.S. Pat. Nos. 4,648,882 and 5,683,976, which are incorporated by reference in their entireties, can be used herein.

In one aspect, the surfactant is anionic, cationic, or neutral. In one aspect, the anionic surfactant can be a sulfate and sulfonate, although other types, such as soaps, long-chain N-acyl sarcosinates, salts of fatty acid cyanamides or salts of ether carboxylic acids, of the type obtainable from long-chain alkyl or alkylphenyl poly-ethylene glycol ethers and chloroacetic acid, can also be used. The anionic surfactant can be used in the form of the alkali metal or alkali earth metal salt.

In one aspect, surfactants of the sulfate type can be sulfuric acid monoesters of long-chain primary alcohols of natural and synthetic origin containing from 10 to 20 carbon atoms, i.e. of fatty alcohols such as, for example, coconut oil fatty alcohols, tallow fatty alcohols, oleyl alcohol, or of C₁₀-C₂₀ oxoalcohols and those of secondary alcohols having chain lengths in the same range. Sulfated fatty acid alkanolamides and sulfated fatty acid monoglycerides are also suitable.

In another aspect, surfactants of the sulfonate type can be a salt of sulfosuccinic acid monoesters and diesters containing from 6 to 22 carbon atoms in the alcohol portions, alkylbenzene sulfonates containing C₉-C₁₅ alkyl groups and lower alkyl esters of α-sulfofatty acids, for example the α-sulfonated methyl or ethylesters of hydrogenated coconut oil fatty acids, hydrogenated palm kernel oil fatty acids or hydrogenated tallow fatty acids. Other suitable surfactants of the sulfonate type are the alkane sulfonates obtainable from C₁₂-C₁₈ alkanes by sulfochlorination or sulfoxidation and subsequent hydrolysis or neutralization or by addition of bisulfites onto C₁₂-C₁₈ olefins and also the olefin sulfonates i.e. mixtures of alkene and hydroxyalkane sulfonates and disulfonates, obtained for example from long-chain monoolefins containing a terminal or internal double bond by sulfonation with gaseous sulfur trioxide and subsequent alkaline or acidic hydrolysis of the sulfonation products.

In one aspect, the surfactant can be a disodium alpha olefin sulfonate, which contains a mixture of C₁₂ to C₁₆ sulfonates. In one aspect, CALSOFT™ AOS-40 manufactured by Pilot Corp. can be used herein as the surfactant. In another aspect, the surfactant is DOWFAX 2A1 or 2G manufactured by Dow Chemical, which are alkyl diphenyl oxide disulfonates.

Any of the compositions described herein can be produced by admixing the fluorinated polyurethane, acrylic polymer, and optional surfactant in any order. The term “admixing” is defined as the mixing of two or more components together so that there is no chemical reaction or physical interaction. The term “admixing” also includes the chemical reaction or physical interaction between any of the components described herein upon mixing to produce the composition. The components can be admixed in any solvent. In one aspect, the components are mixed with water alone or in combination with other solvents.

The components used to produce the compositions described herein can be admixed using techniques described in the art. For example, mixers such as paddle mixers, drum mixers, auger mixers and the like can be used. In one aspect, finely divided solid constituents are initially introduced into the mixer in which they are then sprayed while mixing with the liquid constituents. In another aspect, either the solid components and/or the liquid components are premixed prior to their introduction into the mixer. In one aspect, after thorough blending of the finely divided solid constituents with the liquid constituents, a smooth flowable powder or liquid is produced.

The amounts of each component used to prepare the compositions described herein can vary. In one aspect, the fluorinated polyurethane is from 1% to 30%, 5% to 25%, 10% to 20%, 12% to 18%, or 14% to 16% by weight of the composition. In another aspect, the acrylic polymer is from 1% to 20%, 1% to 10%, 2% to 8%, or 4% to 6% by weight of the composition. In another aspect, when a surfactant is used, the amount of surfactant is 1% to 10% by weight, 1% to 5% by weight, 1% to 3%, or 1% to 2% by weight of the composition.

In another aspect, the composition is composed of an anionic fluorinated polymer (e.g., Fluorolink® P56) in the amount of 10% to 20% by weight of the composition, polyacrylic acid (e.g., RayCryl™ 708E) in the amount of 1% to 10% by weight of the composition, and optionally anionic surfactant (e.g., DOWFAX 2A1 or 2G) in the amount of 1% to 5% by weight of the composition, wherein the remainder of the composition is water. In a further aspect, the composition is composed of Fluorolink® P56 (40% solids) in the amount of about 38% by volume of the composition, RayCryl™ 708E (50% solids) in the amount of 10% by volume of the composition, and optionally DOWFAX 2A1 or 2G (45% solids) in the amount of 3% by volume of the composition, wherein the remainder of the composition is water. In another aspect, the composition includes an anionic fluorinated polymer (e.g., Fluorolink® P56) in the amount of 1% to 90%, 5% to 70%, 7% to 50%, 8% to 40%, 9%, to 30%, or 10% to 20% by weight of the composition, a cationic fluorinated polymer (e.g., Fluorolink® 5032) in the amount of 0.1% to 90%, 0.5% to 40%, 0.75% to 30%, or 1% to 10% by weight of the composition, polyacrylic acid (e.g., RayCryl™ 708E) in the amount of 0.1% to 90%, 0.5% to 40%, 0.75% to 30%, or 1% to 10% by weight of the composition, and water.

In one aspect, any of the compositions described herein can be applied to an article using techniques known in the art. The method for contacting the article with the composition will vary depending upon the article and the form of the composition. In one aspect, the compositions described herein can be in the form of an aqueous medium or a dispersion, such as a foam. Alternatively, the compositions described herein can be dissolved or dispersed in an organic solvent such as, for example, a glycol or polyether, or an aqueous organic solvent. In this aspect, the composition can be applied to the article by spray application. In another aspect, other methods such as, for example, Beck application, Continuous Liquid and Foam application, Flood, Flex Nip, Pad, and Superba (saturated steam continuous heat setting) applications can be used to contact the article with the composition.

In another aspect, when the contacting step involves topical coating, the coating step can be performed by spray, foam, kiss or liquid injection methods and various methods thereof followed by drying in a hot air or radiant heat oven at 160 to 320° F. for a time sufficient to dry the article. In one aspect, a spray application can be applied in a liquid medium (water and chemical treatment) with a wet pickup of 5% to about 200% followed by drying. In another aspect, a foam application can be applied in a liquid medium (water and chemical treatment) with a wet pickup of 5% to about 200%. In this aspect, the foam can be applied by a direct puddle application with a press roll, an injection manifold and/or a sub-surface extraction device. Subsequent drying in a hot air or radiant heat oven at 160 to 320° F. for a time sufficient to dry the article should follow.

The prevailing plant conditions will also affect the amount of composition to be applied to the article to achieve the desired odor resistance. The composition of the article will also influence the amount of composition to be applied.

Application conditions such as pH, temperature, steam and drying time can vary. In one aspect, the pH range for the compositions described herein is from about 1.0 to about 11.0. Still further, the pH of the compositions of the present invention can be from 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5 or 11.0 where any value can be used as an upper or a lower endpoint, as appropriate. As would be recognized by one of ordinary skill in the art, the amount of pH adjustment needed prior to use of the compositions will depend on the amount of each component in the composition. Further, pH adjustment of the composition prior to use can be by methods known to one of ordinary skill in the art, such as the addition of acid or base, as appropriate.

The temperature at which the article is contacted by the compositions described herein range from ambient to temperatures up to 100° C. at atmospheric pressure and above 100° C. under pressure conditions (closed atmosphere). Still further, the temperature of application can be from 25, 35, 45, 55, 65, 75, 85 or 100° C., where any value can form an upper or a lower end point, as appropriate. In another aspect, the composition can be cured at ambient temperature once applied to the substrate.

Where production procedures warrant, steam can aid in the efficacy of the compositions herein when applied by, but not limited to Beck, Continuous liquid, Flood, Flex Nip, Superba, and Pad applications. The steam time can vary from about 15 seconds to about 10 minutes, or from about 2 minutes to about 8 minutes. Still further, the application time can be from about 15 seconds or 1, 2, 3, 4, 5, 6, 7, 8, 9 or 10 minutes, where any value can form an upper or a lower end point, as appropriate. In certain applications, but not limited to Spray Application and Foam Application, drying with forced heat can aid in the fixing of the composition to the article. In one aspect, the coated article can be dried with forced air. In another aspect, the coated article can be dried with microwave heat. The drying time is generally dependent upon varying conditions predicated by moisture content, range speed, type construction, the weight of the substrate, etc. The drying time can vary from 30 seconds to 15 minutes. Still further, the drying time can be from 15 seconds or 1, 3, 5, 7, 9, 10, 12, or 15 minutes, where any value can be used as an upper or lower endpoint, as appropriate.

In one aspect, the weight ratio of the composition can vary between 0.5% to 600% of wet pick up where such amount is based on the weight of the article and the composition that is used. The weight ratio will vary dependent on the manner of application. In other aspects, the owf (“on weight fiber”) amount of the composition that can be applied to the article is from 0.05, 0.1, 0.2, 0.5, 1, 2, 3, 4, 5, 6, 7, 8, 9, 10, 20, 30, 50, 70, 100, 120, 150, 200, 250, 300, 350, 400, 450, 500, 550 or 600% as measured by weight of the article, where any value can be used as an upper or lower endpoint, as appropriate. In one aspect, the owf amount of the composition that is applied to the article is from 5% to 50%, 10% to 40%, or 10% to 30%.

In one aspect, once the article has been contacted with the composition, the article can be further treated to remove any composition that is not bound to the article.

Also contemplated are articles treated with any of the compositions described herein. In one aspect, the article can be composed of any material that can receive and that will adhere to the composition where odor-resistance is desirable. Examples of articles include, but are not limited to, bedding (e.g., blankets, sheets, pillowcases, futon or comforter covers, comforter wadding), clothes (e.g., suits, uniforms, shirts, blouses, trousers, skirts, sweaters, socks, panty hoses, shoe linings, shoe sole inserts), curtains, carpet, diapers, incontinent pads, surgical sponges and dressings, surgical pads, or catamenial devices such as sanitary napkins, shields, liners, or tampons.

In one aspect, the article is composed of natural and/or synthetic fibers. In one aspect, the synthetic fiber includes, but is not limited to, polyamide fibers (e.g., nylons), polyester fibers, polypropylene fibers, synthetic fibers containing free amino groups, and derivatives thereof such as nylon covered with polypropylene. Fibers containing free amino groups can be obtained by a variety of methods, including, but not limited to, the condensation reaction of hexamethylenediamine with adipic acid, hexamethylenediamine with sebacic acid, ξ-aminodecanoic acid, caprolactam and dodecylcaprolactam. Fibers formed from polyaryl amides, including type 6 and type 6,6 nylons, can be treated by the compositions and methods described herein. Examples of natural fibers include, but are not limited to, cotton, wool, and flax. Semisynthetic fibers such as rayon can also be contacted with any of the compositions described herein. In one aspect, the fibers are Dupont's Antron®, Sorona® yarn manufactured by Dupont, and Corterra® (polytrimethylene terephthalate) manufactured by Shell Chemicals.

The fibers treated with the compositions and methods described herein can be twisted, woven, tufted and sewn into various forms of textile materials including, but not limited to, rugs, carpets, and yarns. The fibers can be treated and then formed into the various forms of textile materials, or the formed textile can be treated.

In one aspect, the compositions described herein can impart water and oil repellency to an article. As shown in the Examples, the combination of the fluorinated polyurethane and acrylic polymer enhance the oil and water repellent properties of each other. In other words, the combination of the fluorinated polyurethane and acrylic polymer provides increased oil and water repellency when compared to the oil and water repellency provided by the individual components. As demonstrated in the Example, the compositions described herein impart longer oil and water repellency when imparted to fibers.

### Examples

The following examples are put forth so as to provide those of ordinary skill in the art with a complete disclosure and description of how the compositions and methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

### Example 1

Fluorolink P56 (40% solids) and RayCryl 708E (50% solids) were used to produce the compositions tested below. Three compositions were tested (A-C), where each composition contained 5% by volume Fluorolink P56, 3% by volume DOWFAX 2A1, and varying amounts of RayCryl 708E (5% by volume for A, 10% by volume for B, and 17% by volume for C). The balance of the composition was water. Each composition was topically applied to the fibers at 20% wpu and subsequently dry cured. The water and oil repellency was measured as a function of time, where a drop of water or oil was placed on the carpet fiber pretreated with the compositions listed below and the time was measured from the time the drop was placed on the fiber to the time the drop disappeared.

### Gray Level Loop Carpet Unbacked

| | | 500 ppm | 500 ppm | |
|---|---|---|---|---|
| Sample | Product | Water Repel. | Oil Repel. | |
| Set #1 | A 1% owg | 5 min.+ | 30 | sec. |
| | B 1% owg | 5 min.+ | 30 | sec. |
| | C 1% owg | 5 min+ | 1 | min. |

### Gray Level Loop Carpet Backed

| | | 500 ppm | 500 ppm | | Oil Recheck | |
|---|---|---|---|---|---|---|
| Sample | Product | Water Repel. | Oil Repel. | | 4 hr. later | |
| Set #2 | A 1% owg | 5 min.+ | 24 | sec. | 24 | sec. Later |
| | B 1% owg | 5 min.+ | 30 | sec. | 2 | min. |
| | C 1% owg | 5 min.+ | 30 | sec. | 1 | min. |
| | P56 Only .38% | 5 min. | 5 | sec. | 5 | sec. |
| | 708E Only 1% | 5 min. | 0 | | | |

### Gray Level Loop Carpet Unbacked

| | | 300 ppm | 300 ppm | |
|---|---|---|---|---|
| Sample | Product | Water Repel | Oil Repel | |
| Set #3 | A .6 owg | 5 min.+ | 4 | sec. |
| | B .6 owg | 5 min.+ | 4 | sec. |
| | C .6 owg | 5 min.+ | 8 | sec. |
| | P56 Only .23% | 5 min.+ | 3 | sec. |
| | 708E Only 1% | 3 min. | 0 | |

Gray level loop carpet backed

| | | 300 ppm | 300 ppm | |
|---|---|---|---|---|
| Sample | Product | Water Repel | Oil Repel | |
| Set #4 | A .6% owg | 5 min.+ | 30 | sec. |
| | B .6% owg | 5 min.+ | 5 | min.+ |
| | C .6% owg | 5 min.+ | 5 | min.+ |
| | P56 Only 23% | 5 min.+ | 30 | sec. |

### Gray Level Loop Carpet Unbacked

| | | 500 ppm | 500 ppm |
|---|---|---|---|
| Sample | Product | Water Repel | Oil Repel |
| Set #5 | 708E Only | 5 min. | 0 |
| | 1% owg | | |
| | 708E Only | 3 min. | 0 |
| | 1% owg | | |

Referring to sample 2 above, the application of 708E (acrylic polymer) only imparted water repellency to the carpet. Similarly, the application of Fluorolink P56 to the carpet imparted minimal oil repellency. When compositions A-C were applied to the carpet, the carpet exhibited water repellency comparable to that of 708E and P56, but a significant increase in oil repellency was also observed (24-30 seconds for A-C vs. 0-5 seconds for 708E and P56 separately). Similar increases in oil repellency were observed in sample sets 3 and 4.

### Example 2

Fluorolink P56 (40% solids), Fluorolink 5032 (25% solids), and RayCryl 708E to (50% solids) were used to produce the compositions tested below. The following composition (Composition A) was prepared an evaluated (amounts by % volume):

| | |
|---|---|
| Water | 45.2% |
| Compatibility Agent | 3.0% |
| Fluorolink 5032 | 8.8% |
| Fluorolink P-56 | 30.0% |
| 708E | 10.0% |
| Arrofoam 2273 | 3.0% |

No pH adjustment of Composition A was required for application. Lab samples meet the following established requirements @ 1% owg: water repellency, oil repellency, soil release

Composition A was compatible with exhaust applied stainblocks when topically applied to fibers. Production application trial with Composition A at 1% owg had oil and water repellency that passed established requirements. Water repellency was excellent.
1. Water Repellency 5+min Oil Repellency 3 min.
2. Untreated carpet has water repellency of 1 second and oil repellency of 0 seconds.

Lab samples applied with Composition A were tested for 40 Hours Lightfastness using AATCC Test Method 16 Colorfastness to Xenon Light. The results are shown below, which indicates that Composition A does not adversely affect lightfasteness when used in combination with the stainblockers Arroshield CSBI-123 and Arroshield SPF-SB.

| Application | 40 Hr. Light Grade |
|---|---|
| 1% owg Comp. A | 4 |
| 1% owg Comp. A + 2% CSBI-123 | 4 |
| 2% owg Comp. A + 2% SPF-SB | 4 |
| Control Carpet (No Treatment) | 4 |

Lab samples applied with Composition A alone and in combination with stainblockers were tested for 1 cycle Oxides of Nitrogen using AATCC Test Method to 164; Colorfastness to Oxides of Nitrogen in the Atmosphere Under High Humidity. The results indicates that Composition A does diminish oxides of nitrogen yellowing, but slightly improves test numbers.

| Application | 1 Cycle Grade |
|---|---|
| 1% owg Comp. A | 2.5 |
| 1% owg Comp. A + 2% CSBI-123 | 2.0 |
| 2% owg Comp. A + 2% SPF-SB | 2.5 |
| Control Carpet | 2.0 |

Lab samples applied with Composition A alone and in combination with stainblockers were tested for Red Dye Stain using AATCC Test Method 175-1993. Although there was a concern that Fluorolink 5032 present in Composition A might cause red tipping, all applications looked good. Arroshield GBSB was applied by exhaust method and Composition A was topically applied.

| | Red Dye |
|---|---|
| Application | Stain Rating |
| 1% owg Composition A + 2% CSBI-123 | 10 |
| 2% owg Composition A + 2% SPF-SB | 10 |
| 2.5% owg GBSB (exhaust) + 1% | 10 |
| Composition A Topical | |

Accelerated Dry Soiling Testing. Samples were exposed to accelerated dry soil testing to compare impact of product in regards to dry soil repellency. The results were graded on a 1-5 scale, with 5 being the best.

| Product 1% owg | Soil Grade |
|---|---|
| Composition A | 5 |
| Control (No Treatment) | 2 |
| Generic A (C-8 bases) | 5 |
| Fluorolink P-56 | 4 |
| Product B (C-6 based) | 3 |
| Product C (C-6 based) | 1 |
| Product D (C-8 based) | 3 |

All applications of Composition A were topically applied by spray or foaming. Composition A does foam sufficiently for puddle foam application without having to add addition foaming agents. The results indicate that Composition A provided superior dry soil repellency compared to other formulations.

Comparative testing was performed to evaluate the effect Fluorolink 5032 has on the composition when used in combination with Fluorolink P56. With the addition of Fluorolink 5032, the oil repellency was increased by as much as 50% when used in combination with Fluorolink P56 when compared to just Fluorolink P56. Water repellency remained about the same. The results are provided below.

| | | |
|---|---|---|
| Comp. A | Water Repellency 5+mins. | Oil Repellency 2 mins. 15 sec. |
| w/o 5032 | | |
| Comp. A | Water Repellency 5+mins. | Oil Repellency 4 mins. |

In another experiment, Composition A was applied to several carpet samples at 0.5% to 1% owg. Once again, the samples exceeded the standard of 10 seconds repellency for passing. The water repellency was 5+ minutes, and oil repellency was 3 min. 10 sec.

Throughout this application, various publications are referenced. The disclosures of these publications in their entireties are hereby incorporated by reference into this application in order to more fully describe the compounds, compositions and methods described herein.

Various modifications and variations can be made to the materials, methods, and articles described herein. Other aspects of the materials, methods, and articles described herein will be apparent from consideration of the specification and practice of the materials, methods, and articles disclosed herein. It is intended that the specification and examples be considered as exemplary.

What is claimed:

1. A composition for imparting water and oil repellency to a fiber, the composition comprising (a) a fluorinated polyurethane comprising a plurality of ionizable groups and (b) an acrylic polymer.

2. The composition of claim 1, wherein the fluorinated polyurethane comprises a mixture of a cationic fluorinated polyurethane and an anionic fluorinated polyurethane.

3. The composition of claim 1, wherein the ionizable groups comprise cationic groups, anionic groups, or a combination thereof.

4. The composition of claim 1, wherein the ionizable group comprises cationic groups, and the cationic groups comprise amine groups.

5. The composition of claim 1, wherein the ionizable groups comprise anionic groups.

6. The composition of claim 1, wherein the ionizable group comprises anionic groups, and the anionic groups comprise carboxylic acid groups.

7. The composition of claim 1, wherein the fluorinated polyurethane comprises a perfluoropolyether unit having a molecular weight less than 5,000.

8. The composition of claim 7, wherein the molecular weight is from 500 to 2,500.

9. The composition of claim 1, wherein the acrylic polymer comprises a homopolymer or copolymer of acrylic acid, methacrylic acid, styrene, vinyl acrylic acid, or any combination thereof.

10. The composition of claim 1, wherein the acrylic polymer comprises polyacrylic acid.

11. The composition of claim 1, wherein the acrylic polymer comprises a polymer having a T_{g} less than 30° C.

12. The composition of claim 1, wherein the acrylic polymer comprises a polymer having a T_{g} less than or equal to 25° C.

13. The composition of claim 1, wherein the acrylic polymer comprises a minimum film forming temperature of less than or equal to 30° C.

14. The composition of claim 1, wherein the acrylic polymer comprises a minimum film forming temperature of less than or equal to 20° C.

15. The composition of claim 1, wherein the acrylic polymer comprises a molecular weight from 10,000 to 2,000,000.

16. The composition of claim 1, wherein the acrylic polymer comprises a molecular weight from 200,000 to 1,500,000.

17. The composition of claim 1, wherein the acrylic polymer comprises a molecular weight from 200,000 to 1,000,000.

18. The composition of claim 1, wherein the acrylic polymer comprises polyacrylic acid having a molecular weight from 200,000 to 1,000,000.

19. The composition of claim 1, wherein the composition further comprises a surfactant.

20. The composition of claim 19, wherein the surfactant comprises a neutral surfactant or cationic surfactant.

21. The composition of claim 19, wherein the surfactant comprises an anionic surfactant.

22. The composition of claim 19, wherein the surfactant comprises an alkyl diphenyl oxide disulfonates.

23. The composition of claim 19, wherein the surfactant comprises from 1% to 5% by weight of the composition.

24. The composition of claim 1, wherein the composition is an aqueous composition.

25. The composition of claim 1, wherein the composition comprises an anionic fluorinated polymer in the amount of 1% to 90% by weight of the composition, a cationic fluorinated polymer in the amount of 0.1% to 90% by weight of the composition, and the acrylic polymer is polyacrylic acid in the amount of 0.1% to 90% by weight of the composition.

26. A composition made by the process comprising admixing an anionic fluorinated polyurethane, a cationic fluorinated polyurethane, and an acrylic polymer in water.

27. A method for imparting water and oil repellency to an article, comprising contacting the article with the composition of claim 1.

28. An article comprising the composition of claim 1.

29. A fiber comprising the composition of claim 1.
